(19) United States
(12) Patent Application Publication
(10) Pub. No.: US 2016/0180272 A1
(43) Pub. Date: Jun. 23, 2016

(54) COLLISION CALENDAR TOOL

(71) Applicant: TARGET BRANDS INC., Minneapolis, MN (US)

(72) Inventors: Trisha RICHARDS, Plymouth, MN (US); Andrea BREAMER, Richfield, MN (US); Michael WEISHAIR, Ramsey, MN (US); Andrew BALLWEBER, Coon Rapids, MN (US); Kaushik DAS, Bangalore (IN); Lindsay EBERLEIN, St. Paul, MN (US)

(21) Appl. No.: 14/573,723

(22) Filed: Dec. 17, 2014

(51) Int. Cl. G06Q 10/06; G06F 3/0484

(52) U.S. Cl. CPC G06Q 10/06314; G06F 3/0484

(57) ABSTRACT

A computer-implemented method, system and user interface for visually representing collisions between a plurality of projects within an organization via a graphical user interface (GUI) on a display of a user device are described. The method includes storing a plurality of survey questions in a survey database. The method further includes, via a collision calendar tool that is accessible from the user device, receiving, from the user device, a plurality of survey answers and project-related information, the project-related information identifying one or more details of a project, the survey answers corresponding to the survey questions; determining a collision score based on the survey answers; and displaying, on the display of the user device, a collision identifier representative of the collision score.

### BACKGROUND

An organization such as a business commonly includes a variety of different subdivisions (e.g., business units, project teams, departments, or the like). Some members of the organization may drive the direction of the organization, but may not be involved in the specific details of each and every subdivision. In order to keep these members abreast of the various ongoing projects, resource utilization, and the like, members of the organization often have checkpoint meetings in order to provide the information. These meetings require a time investment, which can detract from the organization's general productivity. Improved ways to present the interrelationship of the various projects and activities impacts of the projects and activities on other projects and activities, overlap between resources, or the like) within an organization are desirable.

### SUMMARY

A computer-implemented method for visually representing collisions between a plurality of projects within an organization via a graphical user interface (GUI) on a display of a user device is described. The method includes storing a plurality of survey questions in a survey database. The method further includes, via a collision calendar tool that is accessible from the user device, receiving, from the user device, a plurality of survey answers and project-related information, the project-related information identifying one or more details of a project, the survey answers corresponding to the survey questions; determining a collision score based on the survey answers; and displaying, on the display of the user device, a collision identifier representative of the collision score.

A system is described. The system includes a collision calendar tool that is loadable onto a user device, and that when loaded onto the user device permits the user device to receive project details including one or more responses to impact analysis questions, communicate with at least one server to send the server the project details and to receive from the server impacts of a project, and to cause to display a plurality of impact identifiers on a display of the user device. The system further includes a server communicable with the collision calendar tool, the at least one server configured to receive the one or more responses to the impact analysis questions, determine an impact from the one or more responses, and send the impact to the collision calendar tool. The impact sent to the collision calendar tool causes display of the impact identifiers that differs according to the impact as determined by the one or more responses to the impact analysis questions.

A collision calendar interface is described. The collision calendar interface includes an application loadable onto a user device. The application is configured to provide an input user interface for entering information about one or more projects within an organization, the input user interface viewable on the user device and displaying a plurality of fillable project-related fields and a plurality of survey questions. Each survey question has a corresponding set of survey answers representative of collisions between the one or more projects within the organization.

The application also includes a reporting user interface including a collision visualization means for visually representing the collisions.

### BRIEF DESCRIPTION OF THE DRAWINGS

References are made to the accompanying drawings that form apart of this disclosure, and which illustrate the embodiments in which the systems and methods described in this specification can be practiced.

FIG. 1 is a schematic diagram of a system for implementing a collision calendar tool as described herein, according to an embodiment,

FIG. 2 is flowchart of a process for implementing the collision calendar tool of FIG. 1, according to an embodiment.

FIG. 3 is a schematic diagram of a data gathering user interface for the collision calendar tool as described herein, according to an embodiment,

FIG. 4 is a schematic diagram of another data gathering user interface for the collision calendar tool as described herein, according to an embodiment.

FIG. 5 is a schematic diagram of a reporting user interface for the collision calendar tool as described herein, according to an embodiment.

FIG. 6 is a schematic diagram of another reporting user interface for the collision calendar tool as described herein, according to an embodiment.

FIG. 7 is a schematic diagram of yet another reporting user interface for the collision calendar tool as described herein, according to an embodiment.

FIG. 8 is a schematic diagram of an architecture for a computing device, according to an embodiment.

Like reference numbers represent like parts throughout.

### DETAILED DESCRIPTION

This disclosure generally relates to project management within an organization. More particularly, this disclosure relates to systems and methods for creating a visualization of a plurality of ongoing projects within an organization. In an embodiment, the visualization of the ongoing projects can provide an indication of the interrelationship between the projects, for example, whether there are potential collisions between the various projects within the organization. Examples of collisions include, but are not limited to, whether a particular subdivision of the organization will be impacted by multiple projects which could result in delay of implementing one or more of the projects, whether a particular division within the organization would benefit from shifting resources (e.g., hardware, employees, or the like) from one subdivision or project to another, combinations thereof, or the like. The systems and methods described in this Specification include gathering project-related information, analyzing the project-related information, and visually displaying results of the analysis.

In some embodiments, a collision calendar tool can identify one or more subdivisions within an organization in which there is too much change being introduced at once. In some embodiments, too much change being introduced at once can stress the organization. Accordingly, in some embodiments, the collision calendar tool can be used to inform decisions concerning project timing, rollout strategy, engagement of relevant parties, combinations thereof, or the like. In some embodiments, this can reduce the stress on the organization of implementing too much change at once.

In some embodiments, the collision calendar tool can be used to identify opportunities to align various subdivisions of the organization and reduce impacts to the organization,

In some embodiments, the collision calendar tool can be used to bring visibility to all major initiatives within an organization. In a particular embodiment, the collision calendar tool can be used within a retail organization.

A “collision,” as used in this Specification, includes, but is not limited to, an overlap between projects within an organization. A collision can alternatively be referred to as an impact or a conflict. Examples of collisions includes, but are not limited to, whether a particular subdivision of the organization will be impacted by multiple projects which could result in delay of implementing one or more of the projects, whether a particular subdivision within the organization would benefit from shifting resources (e.g., hardware, employees, or the like) from one division or project to another, combinations thereof, or the like.

An “organization,” as used in this Specification, includes, but is not limited to, a body of people with a particular purpose. Examples of organizations include, but are not limited to, businesses, societies, associations, or the like.

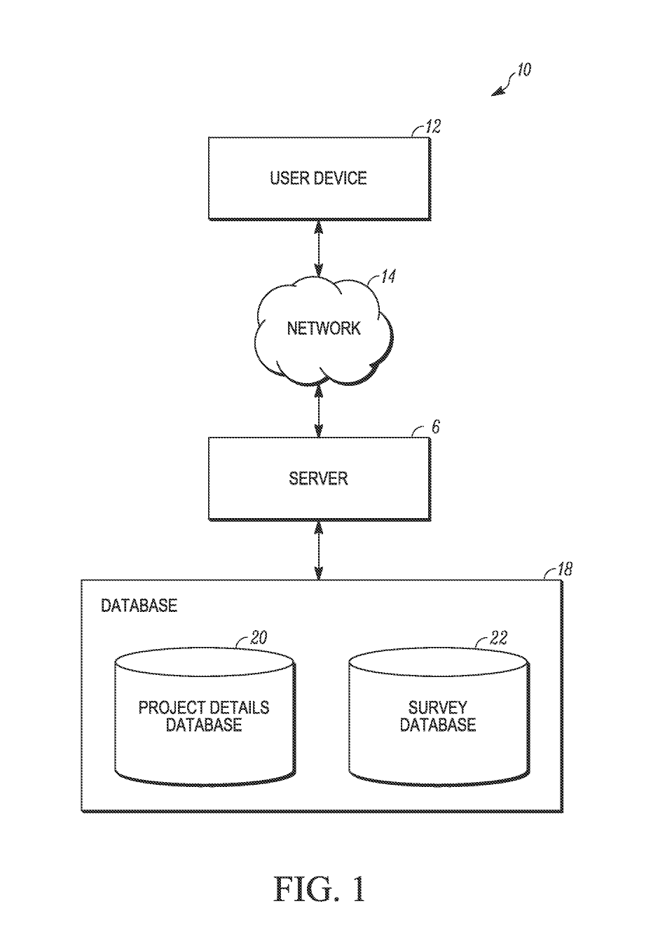

FIG. 1 is a schematic diagram of a system 10 for implementing a collision calendar tool as described herein, according to an embodiment.

In the system 10, a user device 12 is connected in communication with a server 16 via a network 14. The collision calendar tool can be loaded onto the user device 12 that enables a user to view and/or analyze a collision calendar of ongoing projects within an organization. The collision calendar tool can, for example, allow the user to select a plurality of different views in order to visualize the interaction between various projects and resources within the organization.

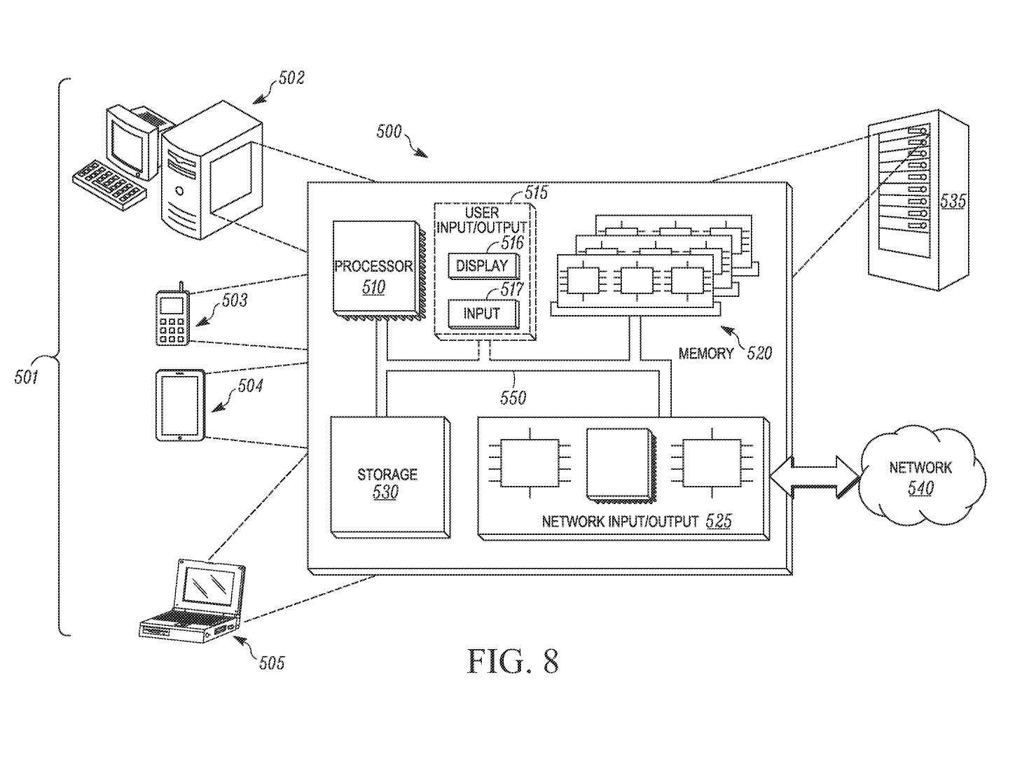

The server 16 can make a graphical user interface (GUI) available to the user device 12. The server 16 makes the GUI available over the network 14 according to principles known in the art suitable for allowing a user to access and view the GUI with the user device 12. In an embodiment, aspects of the server 16 are the same as or similar to aspects of a server device 535 as described in accordance with FIG. 8 below. It is to be appreciated that the application loaded on to the user device 12 can include one or more features of the server 16. For example, the application can make the GUI available to the user device 12 in an embodiment. Further, in an embodiment, the application can include a database of survey information or the like such that the information can be retrieved from the user device 12 rather than being obtained over the network 14 from the server 16.

The network 14 can include, but is not limited to, a local area network (LAN), a wide area network (WAN), a wireless network, a cellular data network, or the like. The network 14 can be a wired network, a wireless network, or suitable combination thereof. In an embodiment, aspects of the network 14 can be the same as or similar to aspects of a network 540 as described in accordance with FIG. 8 below.

The server 16 is in communication with a database 18. The database 18 generally includes information relating to the variety of projects within the organization. In the illustrated embodiment, the database 18 includes a project details database 20 and a survey database 22. It is to be appreciated that the database 18 can include fewer or additional databases. For example, the database 18 can additionally include a user permissions database with various user permission groups for the collision calendar tool, an organization member database that contains the various roles and assignments corresponding to the members of the organization (e.g., employees in the case that the organization is a business), or the like. In some embodiments, the organization member database can, for example, be a human resources database.

The project details database 20 can, for example, include information related to each project. That is, in an embodiment, the project details database 20 can include, but is not limited to, information such as a project name, a program name of which the project is part, a project description, start and end dates for the project, contacts, project phase information, resources required, or the like. It is to be appreciated that the above information is intended as an example, and that the project related information can be stored in a plurality of databases.

The database 18 also includes the survey database 22. The survey database 22 can, for example, include a plurality of survey questions which can be used as an input when analyzing the collisions between projects. For example, the survey questions can be directed at obtaining information relating to work reduced or eliminated, new tasks or work increased, required behavior changes, skill changes, new or upgraded systems, or the like. It is to be appreciated that the number and type of survey questions can vary, according to an embodiment.

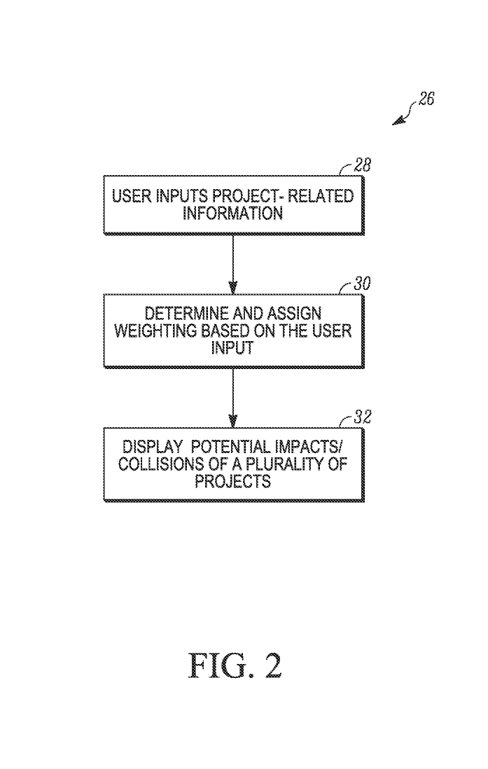

FIG. 2 is flowchart of a process 26 for implementing the collision calendar tool as described herein, according to an embodiment. The process 26 is generally representative of a process by which a user can enter information corresponding to a project and display the potential collisions between a plurality of projects.

The process 26 begins when a user inputs project-related information into the collision calendar tool at 28. The project-related information can include a variety of different project details as well as responding to survey questions corresponding to project-related collisions. Examples of project-related information that can be input at 28 include, but are not limited to, a project name, a program name of which the project is part, a project description, start and end dates for the project, contacts, project phase information, resources required, or the like. It is to be appreciated that the project-related information can be tailored to a particular organization. In an embodiment, the project-related information can be tailored to a particular area/division within the organization.

At 28, the user can also respond to a plurality of survey questions. It is to be appreciated that the survey questions can be presented separately from the gathering of the project-related information, according to some embodiments. The survey questions can be similarly tailored to a particular organization or a particular division within the organization. The survey questions can, for example, be directed at obtaining information relating to work reduced or eliminated, new tasks or work increased, required behavior changes, skill changes, new or upgraded systems, or the like. The number and type of survey questions can vary, according to an embodiment. Each of the survey questions can include a plurality of response options, such as, but not limited to, “High,” “Medium,” “Low,” “NA,” or the like. The response options can be modified to include more options, different options, or the like.

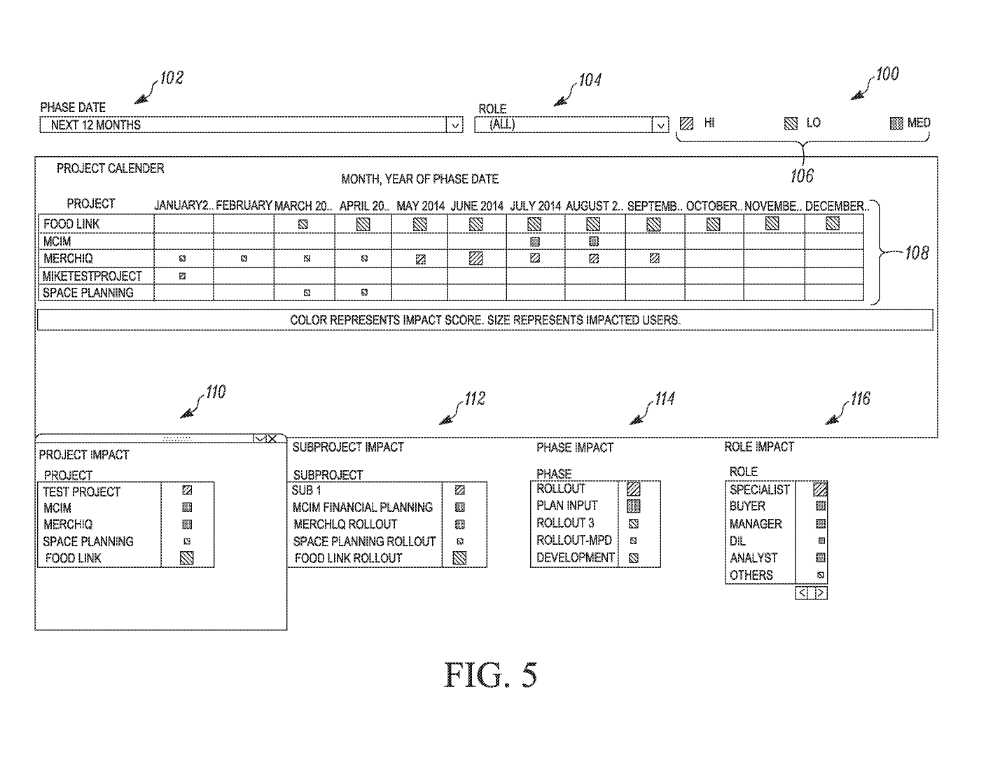

Once the user has input the project-related information, the collision calendar toot determines and assigns weights to the collisions between projects based on the user inputs at 30. This can, for example, include determining a weighting value associated with each survey response and assigning a numerical value or collision factor corresponding to the survey response. For example, in an embodiment, the “High” response can be assigned a weight of 3, “Medium” a weight of 2, “Low” a weight of 1, and “NA” a weight of 0. These values are examples and can be modified. For example, an organization can provide larger variation between the values of each response. The weighted values are then used to format the display at 32. That is, the display of the collisions is dependent upon the weighted values. For example, as illustrated in FIGS. 5-7, collision identifiers (e.g., collision identifiers 105) can be sized and/or colored differently in order to provide a visual distinction of the collisions between different projects. In an embodiment, the weighted values from each category can be used to display different types of collisions. That is, the weighted values can be used to display collisions between, for example, people resources, impacted subdivisions, or the like.

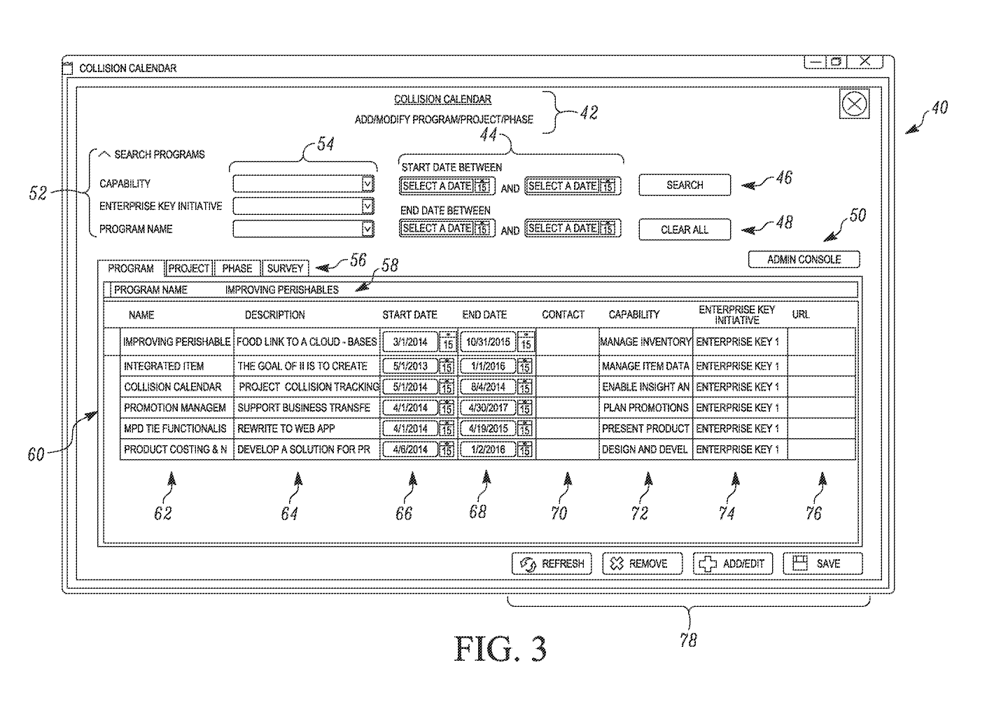

FIG. 3 is a schematic diagram of a data gathering user interface 40A for entering the project-related information into the collision calendar tool as described herein, according to an embodiment. The user interface 40A generally includes a number of fields that permit a user to review information, input information, or delete information from the collision calendar tool, The user interface 40A allows the user to input information that can then be visualized using various reporting interfaces (see FIGS. 5-7 and corresponding description below) in order to graphically view the interrelationships between the various projects within the organization. The text within the figures is intended to be illustrative and not limiting of the features as described herein.

Depending on her rote (e.g., manager, analyst, specialist, or the like) within the organization, a user can be given different privileges within the collision calendar tool. For example, a manager may be able to add, remove, or modify projects and project-related information, whereas an analyst may be given read-only access to the collision calendar tool. The data gathering user interface 40A includes a heading 42. The heading 42 can include, for example, a title of the collision calendar tool and can also include a label indicating the options available to the user within the data gathering user interface 40A (e.g., the user can add/modify a program, a project, or a phase). The data gathering user interface 40A includes a search feature 52 that permits a user to display only the project-related information that is relevant to her within the collision calendar tool. The search feature 52 can be used to control what is displayed in the project list 60. The search feature 52 includes a plurality of fields. For example, as illustrated, there are three fields which the user can select in order to limit the information “Capability,” “Enterprise Key Initiative,” and “Program Name”). It is to be appreciated that these fields are exemplary and can be modified to fit the organization implementing the collision calendar tool. The fields include dropdown selections 54 in order for the user to select the appropriate information. In an embodiment, the user can fill out as much information as is known in order to complete the search. In another embodiment, a response to one or all of the fields may be required. The dropdown selections 54 can be populated to include only the information previously entered, according to an embodiment. The dropdown selections 54 can alternatively be, for example, text boxes, such that a user can freely enter search terms. The search feature 52 can be limited by project dates 44. The project dates 44 can include a start date range and an end date range. The search feature 52 includes a search button 46 which, upon selection, causes the search to be executed with the information filled into the search feature 52. The search feature 52 also includes a clear button 48 which allows a user to reset all of the information filled into the search feature 52.

The data gathering user interface 40A also includes an administration button 50 which can provide a user with an administrator console in which the user can, for example, make modifications to the features of the collision calendar tool. In an embodiment, the administration button 50 may only be displayed (or only selectable) to users having authority to perform such tasks. For example, the administration button 50 may only be visible to a project manager, an information technology (IT) administrator, or the like. It is to be appreciated that the term “button” is not intended to require a specific structure. Buttons, as described herein, include any selectable feature and can be selected by, for example, clicking, hovering (e.g., with a finger in proximity to a user input/output device), touching with a finger, or the like.

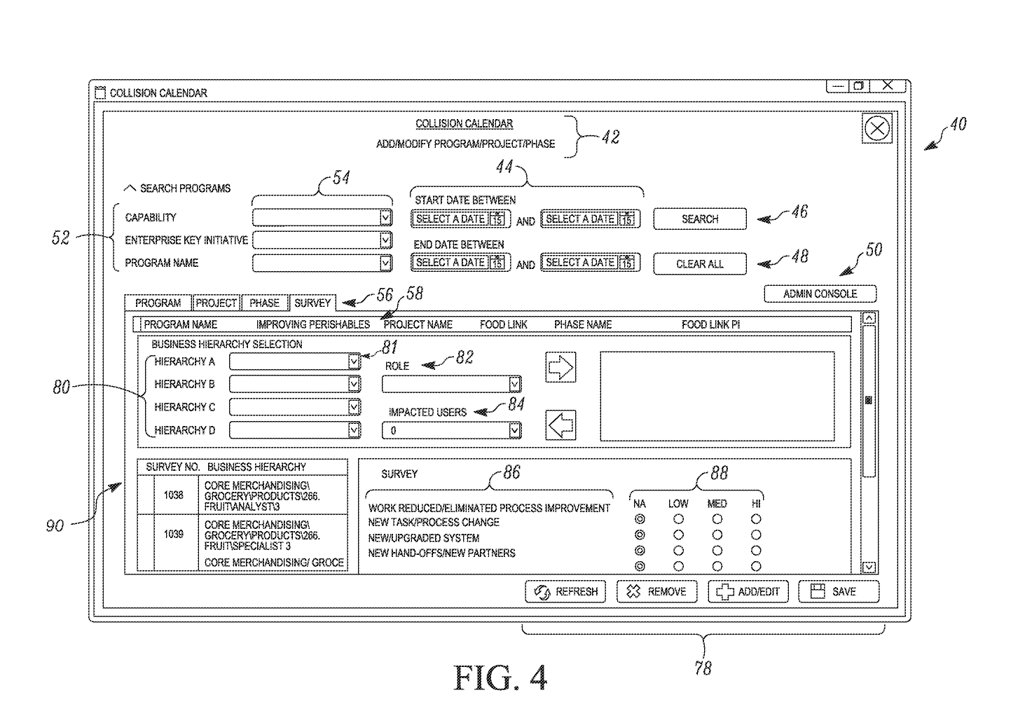

The data gathering user interface 40A includes a tabular selection 56 which allows the user to navigate to different data gathering interfaces (e.g., data gathering interface 40B of FIG. 4). For example, the tabular selection 56 includes the “Program,” “Project,” “Phase,” and “Survey” tab selections in the illustrated embodiment. The user can select the various tabs in order to navigate to different portions of the collision calendar tool and add/modify/remove project-related information. It is to be appreciated that there can be fewer or additional options within the tabular selection 56, according to an embodiment. The data gathering user interface 40 also includes a title 58 that indicates which program the user has selected.

The data gathering user interface 40A includes the program list 60. The program list 60 includes columns 62-76 including data associated with the various programs. The name column 62 includes the name of the program. The description column 64 includes a brief description of the program. The start date column 66 includes a start date for initiating the program and the end date column 68 includes a corresponding end date for the program. The contact column 70 can include identifying contact information for a person within the organization that is identified as the contact for the particular program. In one embodiment, the contact column 70 can include a name, an email address, or the like. A capability column 72 includes a category for the particular program. An enterprise key initiative column 74 can include information relating to which key initiative of the organization this program relates. A URL column 76 can include information identifying a URL associated with the project. This can, for example, be an internal URL at which information about the program can be found. In an embodiment, the URL can be a URL at which the program will be displayed (e.g., on the website of the organization or the like).

The user interface 40A also includes a plurality of buttons 78. The buttons 78 provide options to the user. For example, the buttons 78 in the illustrated embodiment include a “Refresh” button, a “Remove” button, an “Add/Edit” button, and a “Save” button. It is to be appreciated that the buttons 78 can alternatively be a hyperlink or other selectable area.

FIG. 4 is a schematic diagram of a data gathering user interface 40B, according to an embodiment. The data gathering user interface 40B is generally associated with the entry of survey related information that is used as input for analyzing the collisions to be displayed. The data gathering user interface 40B includes aspects that are the same as or similar to aspects of the data gathering user interface 40A. For simplification of this Specification, such features (e.g., the search feature 52) will not be further described in accordance with FIG. 4. The data gathering user interface 40B is associated with the user selecting the “Survey” option on the tabular selection 56.

The data gathering user interface 40B includes the title 58. The title 58 includes additional items in FIG. 4 as compared to FIG. 3 because a particular project and phase have been selected by the user in order to input the survey-related information.

The data gathering user interface 40B includes a role collision feature 80. The role collision feature 80 includes a plurality of hierarchy selections 81, a role selection 82, and an impacted users input 84. The role collision feature 80 permits the user to select areas within the organization corresponding to a project with the hierarchy selections 81. For example. Hierarchy A can be “Core Merchandising.” The user can complete the hierarchy selections 81 in order to define the area of the organization to which the role collision information corresponds. The user additionally selects a particular role (e.g., manager, analyst, specialist, or the like) using the rote selection 82 and inputs a number of impacted users to the impacted users input 84. In an embodiment, the impacted users input 84 is a text box into Which the user can enter any relevant number. In another embodiment, the impacted users input 84 can be a dropdown menu from which the user will select a number of impacted users or a range of impacted users (e.g., >5, >10, or the like).

The data gathering user interface 4013 includes a survey summary 90 that identifies a survey number and its corresponding business hierarchy information including the information entered into the role collision feature 80.

One or more survey questions 86 and corresponding survey answers 88 are displayed on the data gathering user interface 40B. The number of survey questions 86 corresponds to the number of survey answers 88. Four survey questions 86 and four corresponding survey answers 88 are illustrated. It is to be appreciated that there can be fewer or additional survey questions 86 and survey answers 88. For example, in an embodiment, there can be 10 survey questions 86 and 10 corresponding survey answers 88. The number of survey questions 86 and survey answers 88 can Wily based on, for example, the organization, the area of the project within the organization, or the like. In general, the same number and type of survey questions 86 can be used for all areas within an organization, according to an embodiment. In another embodiment, the number and type of survey questions 86 can vary from area to area within the organization. In order to more consistently manage the collisions within an area of the organization, the same number and type of survey questions 86 are generally used for all projects within a particular area of the organization. The survey questions 86 and corresponding survey answers 88 are used to formulate the weighting as described in accordance with FIG. 2 above. The survey answers 88 are illustrated as radio buttons having four different selection options. The survey answers 88 can alternatively be a dropdown selection or the like. Further, the survey answers 88 can include one or more selectable options, according to an embodiment. In the illustrated embodiment, the selectable options are radio buttons that include options for NA, LOW, MED, and HI. It is to be appreciated that the use of radio buttons is intended to be illustrative, and that one or more other selectable options can be alternatively used. For example, the selectable options can be in the form of a dropdown menu, checkbox, or the like.

FIG. 5 is a schematic diagram of a reporting user interface 100A, according to an embodiment. The reporting user interface 100A illustrates a reporting user interface in the collision calendar tool in which the display is shown from a project perspective.

The reporting user interface 100A includes a phase date selection 102. The phase date selection 102 can be, for example, a dropdown menu or other selectable feature so that the user can select timelines for which she would like to view the project collisions. The user can also limit the collisions based on the role with which the collision is associated with a role selection 104. For example, in some cases the user may want to view the collisions for all roles, white in other cases the user may want to display only the collisions for managers. Similar to the phase date selection 102, the role selection 104 can be a dropdown menu or other selectable feature so that the user can select the roles for which she would like to view the project collisions.

A collision score level indicator 106 provides the user with a key for interpreting the display of the collision identifiers 105 on the reporting user interface 100A. In the illustrated collision score level indicator 106, there are three different collision scores—“HI,” “LO,” and “MED.” According to an embodiment, there can be fewer or additional collision scores. As is indicated by collision score level indicator 106A, the color (or gradient in the figures) identifies the particular collision score for a collision identifier 105, while the size of the collision identifier 105 represents the number of impacted users. The various collision identifiers 105 illustrated in FIG. 5 include a variety of sizes and colors (as represented by different gradients). A project collision table 108 provides a monthly breakdown by project of the impacts within an organization. The number of columns in the project collision table 108 is based on the phase date selection 102. By way of example, the collision identifier 105 for the “Food Link” project in May 2014 is “Hi” with a relatively larger number of impacted users as compared to the collision identifier 105 for the “Merch IQ” project in May 2014, which has a “Lo” collision and a relatively fewer number of impacted users. Accordingly, in May 2014 the “Food Link” project has a larger impact on the organization than the “Merch IQ” project.

In addition to the project collision table 108, the reporting user interface 100A includes a project collision table 110, a subproject collision table 112, a phase collision table 114, and a role collision table 116. The project collision table 110 illustrates the impact score and number of impacted users for a given project. The subproject collision table 112 illustrates the impact score and number of impacted users for a given subproject. The phase collision table 114 illustrates the impact score and number of impacted users for the various phases and the role collision table 116 illustrates the impact score and number of impacted users for the various roles within the organization.

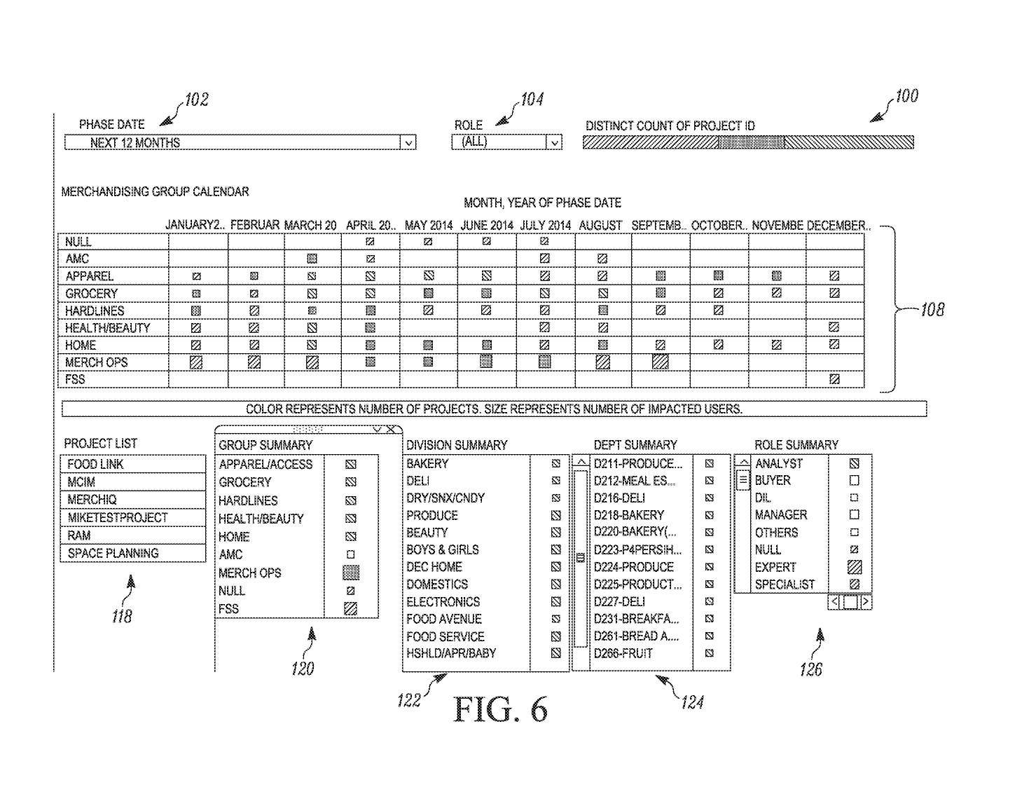

FIG. 6 is a schematic diagram of a reporting user interface 100B, according to an embodiment. The reporting user interface 100B illustrates a reporting user interface in the collision calendar tool in which the reporting user interface 100B is shown from an organizational perspective. Aspects of FIG. 6 can be the same as or similar to aspects of FIG. 5. For simplification of this Specification, such aspects will not be further described in accordance with FIG. 6.

The reporting user interface 100B includes a collision score level indicator 107. The collision score level indicator 107 is similar to the collision score level indicator 106 (FIG. 5). That is, the collision score level indicator 107 provides a key for the visual representations of the collision identifiers 105. Similar to FIG. 5, the reporting user interface 100B includes the project collision table 108 in which the collision identifiers 105 are shown. Rather than displaying the project collision table 108 from a project-by-project perspective, the different rows of the project collision table 108 correspond to different areas within the organization.

A project list table 118 includes a list of projects within the organization. A group summary table 120 illustrates the impact to each of the areas within the organization. A division summary table 122 includes a list of divisions within the areas of the organization and illustrates the impacts to each division. Similarly, a department summary table 124 illustrates the impacts to each department within the organization. A role summary table 126 illustrates the impact of the various projects on the various roles within the organization. The role collision summary table 126 can have aspects that are the same as or similar to aspects of the role collision table 116 (FIG. 5).

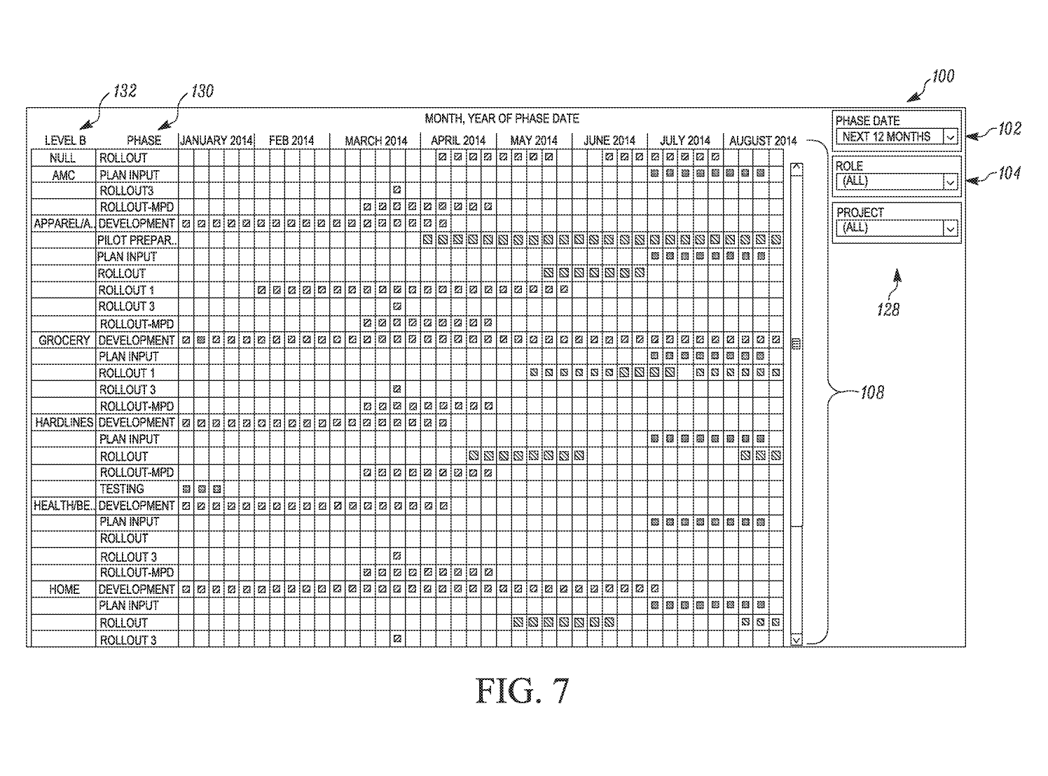

FIG. 7 is a schematic diagram of a reporting user interface 100C, according to an embodiment. The reporting user interface 100C illustrates a reporting user interface in the collision calendar tool in which the reporting user interface 100C is shown from an organizational and a project perspective (e.g., combining the views of the reporting user interfaces 100B-100C). Aspects of FIG. 7 can be the same as or similar to aspects of FIGS. 5 and 6. For simplification of this Specification, such aspects will not be further described in accordance with FIG. 7. The reporting user interface 100C includes the phase date selection 102, the role selection 104, and also includes a project selection 128. The project selection 128 allows the user to tailor the display to a particular project or group of projects. Level B 132 includes various areas within the organization for which the impact assessment is displayed. Phase 130 indicates which phases are impacted for a particular area of the organization.

FIG. 8 is a schematic diagram of an architecture for a computer device 500, according to an embodiment. The computer device 500 and any of the individual components thereof can be used for any of the operations described in accordance with any of the computer-implemented methods described herein.

The computer device 500 generally includes a processor 510, memory 520, a network input/output (I/O) 525, storage 530, and an interconnect 550. The computer device 500 can optionally include a user I/O 515, according to some embodiments. The computer device 500 can be in communication with one or more additional computer devices 500 through a network 540.

The computer device 500 is generally representative of hardware aspects of a variety of user devices 501 and a server device 535. The illustrated user devices 501 are examples and are not intended to be limiting. Examples of the user devices 501 include, but are not limited to, a desktop computer 502, a cellular/mobile phone 503, a tablet device 504, and a laptop computer 505. It is to be appreciated that the user devices 501 can include other devices such as, but not limited to, a personal digital assistant (PDA), a video game console, a television, or the like. In some embodiments, the user devices 501 can alternatively be referred to as client devices 501. In such embodiments, the client devices 501 can be in communication with the server device 535 through the network 540. One or more of the client devices 501 can be in communication with another of the client devices 501 through the network 540 in some embodiments.

The processor 510 can retrieve and execute programming instructions stored in the memory 520 and/or the storage 530. The processor 510 can also store and retrieve application data residing in the memory 520. The interconnect 550 is used to transmit programming instructions and/or application data between the processor 510, the user I/O 515, the Memory 520, the storage 530, and the network I/O 540. The interconnect 550 can, for example, be one or more busses or the like. The processor 510 can be a single processor, multiple processors, or a single processor having multiple processing cores. In some embodiments, the processor 510 can be a single-threaded processor. In some embodiments, the processor 510 can be a multi-threaded processor.

The user I/O 515 can include a display 516 and/or an input 517, according to some embodiments. It is to be appreciated that the user I/O 515 can be one or more devices connected in communication with the computer device 500 that are physically separate from the computer device 500. For example, the display 516 and input 517 for the desktop computer 502 can be connected in communication but be physically separate from the computer device 500. In some embodiments, the display 516 and input 517 can be physically included with the computer device 500 for the desktop computer 502. In some embodiments, the user I/O 515 can physically be part of the user device 501. For example, the cellular/mobile phone 503, the tablet device 504, and the laptop 505 include the display 516 and input 517 that are part of the computer device 500. The server device 535 generally may not include the user I/O 515. In some embodiments, the server device 535 can be connected to the display 516 and input 517.

The display 516 can include any of a variety of display devices suitable for displaying information to the user. Examples of devices suitable for the display 516 include, but are not limited to, a cathode ray tube (CRT) monitor, a liquid crystal display (LCD) monitor, a light emitting diode (LED) monitor, or the like.

The input 517 can include any of a variety of input devices or means suitable for receiving an input from the user. Examples of devices suitable for the input 517 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 517 can be included for the user devices 501. In some embodiments the input 517 can be integrated with the display 516 such that both input and output are performed by the display 516.

The memory 520 is generally included to be representative of a random access memory such as, but not limited to, Static Random Access Memory (SRAM), Dynamic Random Access Memory (DRAM), or Flash. In some embodiments, the memory 520 can be a volatile memory. In some embodiments, the memory 520 can be a non-volatile memory. In some embodiments, at least a portion of the memory can be virtual memory.

The storage 530 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 530 is a computer readable medium. In some embodiments, the storage 530 can include storage that is external to the computer device 500, such as in a cloud.

The network I/O 525 is configured to transmit data via a network 540. The network 540 may alternatively be referred to as the communications network 540. Examples of the network 540 include, but are not limited to, a local area network (LAN), a wide area network (WAN), the Internet, or the like. In some embodiments, the network I/O 525 can transmit data via the network 540 through a wireless connection using WiFi, Bluetooth, or other similar wireless communication protocols. In some embodiments, the computer device 500 can transmit data via the network 540 through a cellular, 3G, 4G, or other wireless protocol. In some embodiments, the network I/O 525 can transmit data via a wire line, an optical fiber cable, or the like. It is to be appreciated that the network I/O 525 can communicate through the network 540 through suitable combinations of the preceding wired and wireless communication methods.

The server device 535 is generally representative of a computer device 500 that can, for example, respond to requests received via the network 540 to provide, for example, data for rendering a website on the user devices 501. The server 535 can be representative of a data server, an application server, an Internet server, or the like.

Aspects described herein can be embodied as a system, method, or a computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are examples only, with the true scope and spirit of the disclosure being indicated by the claims that follow.

What is claimed is:

1. A computer-implemented method for visually representing collisions between a plurality of projects within an organization via a graphical user interface (GUI) on a display of a user device, comprising:
storing a plurality of survey questions in a survey database;
via a collision calendar tool that is accessible from the user device:
receiving, from the user device, a plurality of survey answers and project-related information, the project-related information identifying one or more details of a project, the survey answers corresponding to the survey questions;
determining a collision score based on the survey answers; and
displaying, on the display of the user device, a collision identifier representative of the collision score.

2. The computer-implemented method according to claim 1, wherein the collision identifier graphically depicts the collisions.

3. The computer-implemented method according to claim 1, wherein at least a portion of the survey database is storable on the user device.

4. The computer-implemented method according to claim 1, wherein one of the size and the color of the collision identifier represents a number of users impacted by the project.

5. The computer-implemented method according to claim 4, wherein the other of the size and the color of the collision identifier represents the collision score.

6. The computer-implemented method according to claim 4, wherein the other of the size and the color of the collision identifier represents a total number of projects within a subdivision of the organization.

7. The computer-implemented method according to claim 1, wherein the survey questions are tailored to a particular subdivision of the organization.

8. A system, comprising:
a collision calendar tool that is loadable onto a user device, and that when loaded onto the user device permits the user device to receive project details including one or more responses to impact analysis questions, communicate with at least one server to send the server the project details and to receive from the server impacts of a project, and to cause to display a plurality of impact identifiers on a display of the user device; and
a server communicable with the collision calendar tool, the at least one server configured to receive the one or more responses to the impact analysis questions, determine an impact from the one or more responses, and send the impact to the collision calendar tool,
wherein the impact sent o the collision calendar tool causes display of the impact identifiers that differs according to the impact as determined by the one or more responses to the impact analysis questions.

9. The system of claim 8, wherein one or more of a size and/or a color of the impact identifiers is varied based on the impact.

10. The system of claim 8, wherein one or more of a size and/or a color of the impact identifiers is varied based on a number of users in an organization impacted by the project.

11. The system of claim 8, wherein the impact analysis questions include a common list of questions presented to the user for all projects.

12. The system of claim 8, wherein the impact analysis questions are selected based on a subdivision of an organization.

13. The system of claim 8, wherein the impact is based on a score determined from the one or more responses to the impact analysis questions.

14. A collision calendar interface, comprising:
an application loadable onto a user device, the application configured to provide an input user interface for entering information about one or more projects within an organization, the input user interface viewable on the user device and displaying a plurality of fillable project-related fields and a plurality of survey questions, each survey question having a corresponding set of survey answers, wherein the survey questions are representative of collisions between the one or more projects within the organization, the application also including a reporting user interface including a collision visualization means for visually representing the collisions.

15. The collision calendar interface according to claim 14, wherein the collision visualization means is configured to receive a collision score corresponding to each of the set of survey answers.

16. The collision calendar interface according to claim 15, wherein the collision visualization means displays a collision identifier.

17. The collision calendar interface according to claim 16, wherein the collision identifier includes at least one of changing a size and a color based on the collision score.

18. The collision calendar interface according to claim 17, wherein one of the size and the color of the collision identifier represents a number of impacted users.

19. The collision calendar interface according to claim 17, wherein one of the size and the color of the collision identifier represents a total number of projects in a subdivision of the organization.

20. The collision calendar interface according to claim 14, wherein the plurality of survey questions is selected based on a subdivision of the organization.
